(19) United States
(12) Patent Application Publication
(10) Pub. No.: US 2018/0242565 A1
(43) Pub. Date: Aug. 30, 2018

(54) Lighted Bobber with switch

(71) Applicant: Laven Evans, JR., Glendale, AZ (US)

(72) Inventor: Laven Evans, JR., Glendale, AZ (US)

(21) Appl. No.: 15/364,317

(22) Filed: Nov. 30, 2016

(51) Int. Cl. A01K 93/02

(52) U.S. Cl. CPC A01K 93/02

(57) ABSTRACT

The current invention is a light up fishing bobber. It is specially designed to be used in windy and dark weather conditions. The fishing bobber glows red when in use. It changes color when hit to signify to the user that the bobber has a hit. It will work with any standard fishing reel and line. It is perfect for children, and individuals with poor vision.

### CROSS-REFERENCES TO RELATED APPLICATIONS (IF ANY)

None.

### BACKGROUND

### 1. Field of the Invention

This invention relates to a lighted bobber and particularly one that glows red, and when it has a hit it turns green.

### 2. Description of Prior Art

Fishing for game and sport is one of the more popular activities in the United States. Millions of people fish every weekend as a way to relax.

When fishing in windy and dark conditions, it is easy for a fisherman to lose sight of their bobber in the choppy water. It can also be difficult to tell when they actually have a bite as it is difficult to actually see the bobber.

There is still room for improvement in the art.

### SUMMARY OF THE INVENTION

The current invention relates to a light up fishing bobber. It is specially designed to be used in windy and dark weather conditions. The fishing bobber glows red when in use. It changes color when hit to signify to the user that the bobber has a hit. It will work with any standard fishing reel and line.

The bobber consist of a clear bladder with a top and bottom end, two or more led lights in different colors, a switch and a battery source. The top end has a line attachment while the bottom end has a light attachment with a tension reading means. The bobber will switch the light color when tension is applied to the line indicating a strike on the hook. The bobber will have a power source such as a battery.

It is an improvement over existing art.

### BRIEF DESCRIPTION OF THE DRAWINGS

Without restricting the full scope of this invention, the preferred form of this invention is illustrated in the following drawings:

FIG. 1 shows the bobber in the preferred embodiment;

FIG. 2 show the bobber after the hook has been hit;

FIG. 3 shows the bobber while the hook is hit;

FIG. 4 displays the components of the bobber;

FIG. 5 shows the bobber in an alternative embodiment; and

FIG. 6 show the bobber in an alternative embodiment after the hook has been hit.

### DESCRIPTION OF THE PREFERRED EMBODIMENT

There are a number of significant design features and improvements incorporated within the invention.

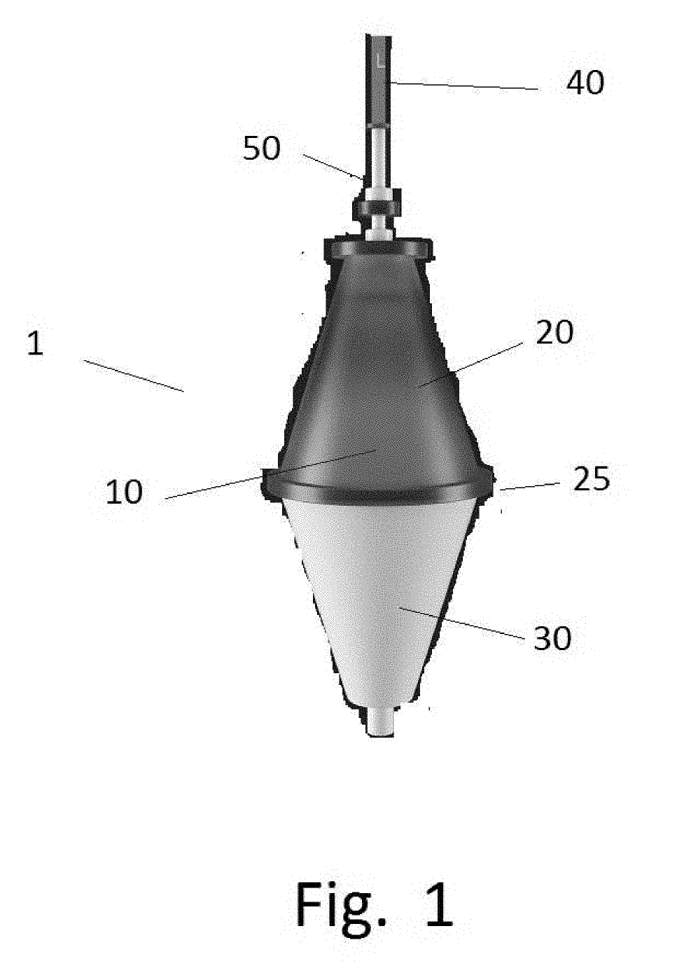

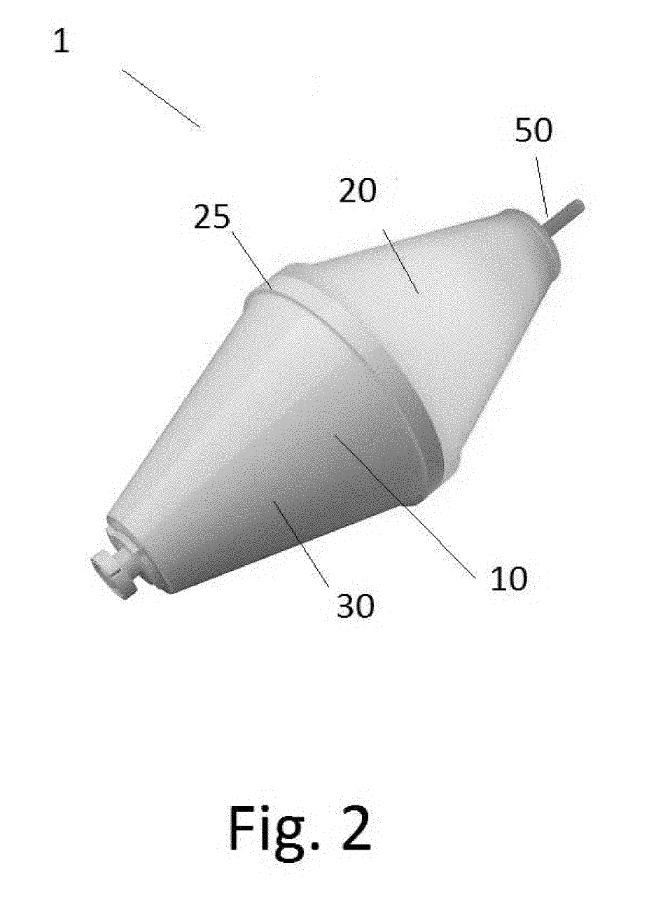

The present invention is a light up fishing bobber 1, as shown in FIGS. 1 through 3.

FIG. 1 shows the visible components of the preferred embodiment. The bobber 1 consists of a a hollow bladder 10. The bladder 10 is made of a conical shaped bottom 30 that is non-translucent and a conical shaped translucent top 20. The top 20 and the bottom 30 are sealed at the bases of the cones forming an airtight seal forming the mid-ridge 25 of the bladder 10. The top 20 and bottom 30 can be connected through any standard connection means like glue or fused together. In one embodiment, either the top 10 and bottom 20 have screw threads so that the bladder 10 can be opened.

The top 20 is attached to a fishing line 40 through the use of a attachment means such as an eyehook or similar means. The bottom 30 attaches to the line 40 with a tension reading means 50.

The bobber 1 will float on water. When there is no tension on the line 40 the bobber 1 will float on its side like a normal bobber.

Within the bladder 10 is one or more lights which can be different colors. In the preferred embodiment, the bobber 1 will have two LED lights, one red light 60 and one green light 70 and one of the lights will be on when the bobber 1 is in use to make it easy to spot at night or in choppy water. In the preferred embodiment, the LED lights would be connected to the bottom 30 of the bobber 1.

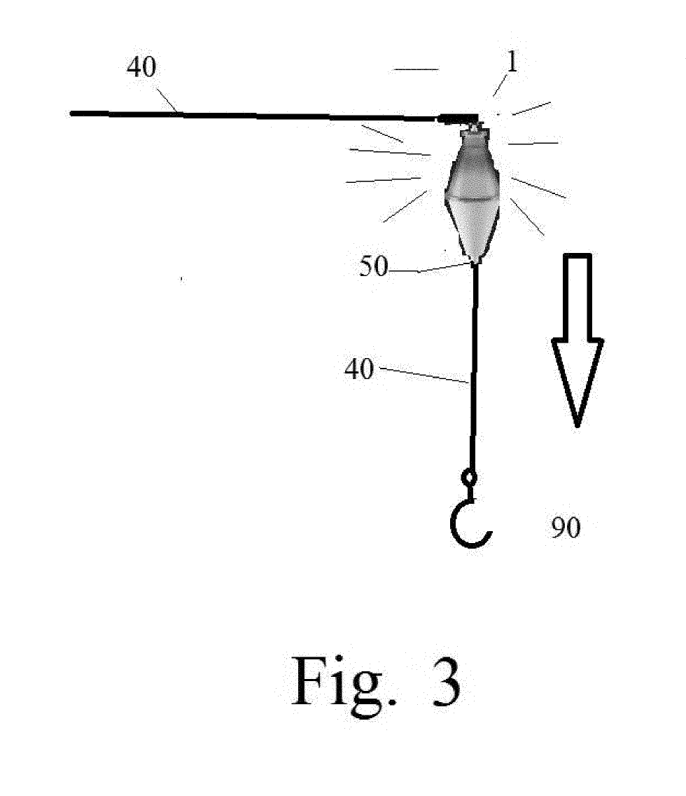

When tension is applied to the line 40 the tension means 50 will cause a switch 80 to switch the color of the lights to indicate a strike on the hook 90 as shown in FIG. 3. In the preferred embodiment, it will switch from the red light 60 to the green one 70. Where green means go! When there is a bite, the bobber 1 turns green. Other colors or light indications can be used.

The bobber 1 will have a power source like self contained long life battery 100. The bobber 1 can be designed to with a battery compartment to switch out the battery or be disposable when the battery life has been used. Other power sources can be used.

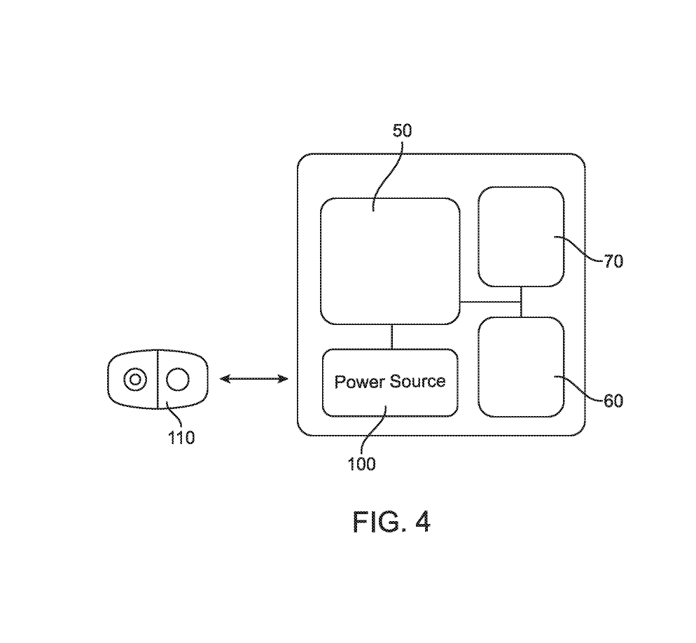

The electrical components are shown in FIG. 4. The battery 100 is connected an on/off switch 110. The battery 100 is connected to the switch 80 which is connected to the lights (60, 70) and the tension means 50.

The tension means 50 can be electronic in nature or can be simple switch where the tension on the line 40 pulls a connection bar which breaks contact between the battery 100 and the red light 60 makes contact between the battery 100 and the green light 70. This can be reset by either manually pushing the connection bar back into place or using a spring or similar device.

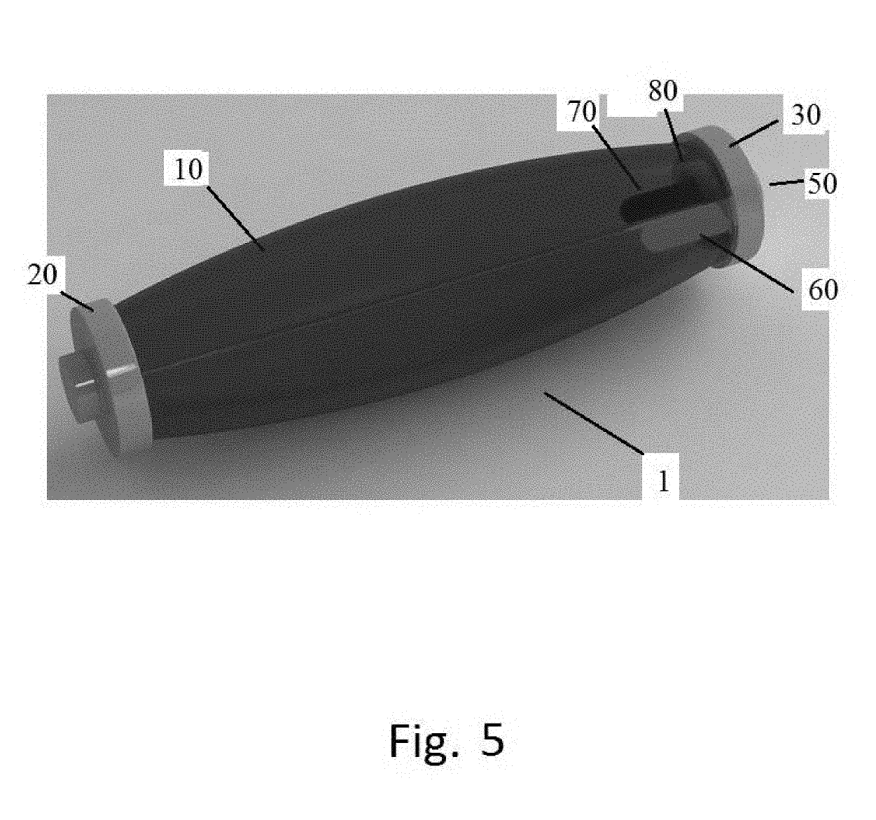

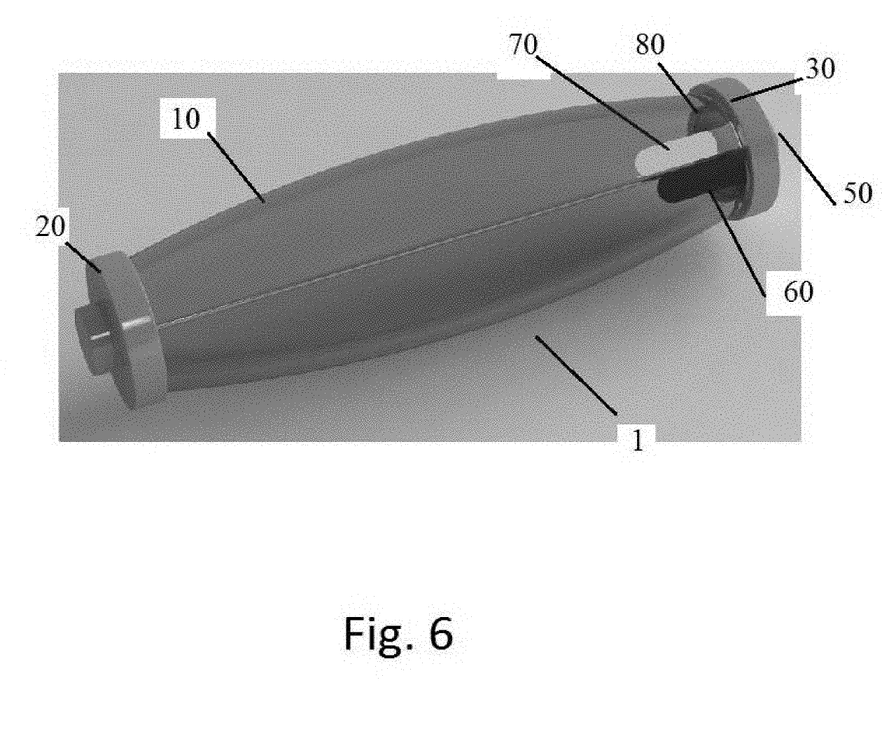

FIGS. 5 and 6 show an alternative embodiment where the bobber 1 consists of a clear elongated cylindrical hollow bladder 10, with a top 20 and a bottom 30 which seals the bladder 10 airtight. In this embodiment, the bladder 10 would be made of a clear plastic with the top 20 and bottom 30 made of a plastic.

Advantages

The current invention has an large number of advantages over the current art. It is perfect for children, and individuals with poor vision. It glows while being used making it easy to see with the light changing color when the hook has been hit. It makes it easy.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A bobber comprising:
a body with top and a bottom with a plurality of lights within the body connected to power source.

2. A bobber according to claim 1 further comprising:
having the top and bottom be conical in shape.

3. A bobber according to claim 1 further comprising:
having a tension reading means.

4. A bobber according to claim 3 further comprising:
having a switch connected to the tension reading means which switches the powers source from one light to another light when tension is applied.

5. A bobber according to claim 4 further comprising:
having the lights be different colors.

6. A bobber according to claim 5 further comprising:
having one light be red and another light be green.

7. A bobber according to claim 6 further comprising:
having the red light lit when there is no tension and the green light lit when there is tension.

8. A bobber according to claim 1 further comprising:
having the lights connected to the bottom.

9. A bobber according to claim 3 further comprising:
having the tension reading means connected to the bottom.

10. A bobber according to claim 1 further comprising:
having the power source be a battery.

11. A bobber according to claim 10 further comprising:
being disposable when the battery power runs out.

12. A bobber comprising:
a body with top and a bottom having a tension reading means with a plurality of lights within the body connected to power source and having a switch connected to the tension reading means which switches the powers source from one light to another light when tension is applied.

13. A bobber according to claim 12 further comprising:
having a cylindrical body.

14. A bobber according to claim 3 further comprising:
having the lights be different colors.

15. A bobber according to claim 14 further comprising:
having one light be red and another light be green.

16. A bobber according to claim 15 further comprising:
having the red light lit when there is no tension and the green light lit when there is tension.

17. A bobber according to claim 12 further comprising:
having the lights connected to the bottom.

18. A bobber according to claim 12 further comprising:
having the power source be a battery.

19. A bobber according to claim 18 further comprising:
being disposable when the battery power runs out.

20. A process using the device according to claim 12.
